(19) United States
(12) Patent Application Publication
(10) Pub. No.: US 2019/0009372 A1
(43) Pub. Date: Jan. 10, 2019

(54) Process of manufacturing copper coil by means of UV laser and copper coil thereof

(71) Applicants: Meng-I Huang, Kaohsiung (TW); Hsueh-Yi Hsiung, Kaohsiung (TW); Po-Nien Su, Kaohsiung (TW)

(72) Inventors: Meng-I Huang, Kaohsiung (TW); Hsueh-Yi Hsiung, Kaohsiung (TW); Po-Nien Su, Kaohsiung (TW)

(21) Appl. No.: 16/137,552

(22) Filed: Sep. 21, 2018

(51) Int. Cl. B23K 26/38

(52) U.S. Cl. CPC B23K 26/38

(57) ABSTRACT

A process of manufacturing a copper coil includes positioning a piece of copper having a thickness of at least 100 μm and flattening same; spirally cutting the piece of copper by means of UV laser to form a plurality of links and a plurality of grooves at either side of each link wherein the links are formed by portions of the piece of copper not cut by the UV laser; and cutting the links by means of the UV laser to connect the grooves together to finish a copper coil. A copper coil is also provided.

### BACKGROUND OF THE INVENTION

### 1. Field of the Invention

The invention relates to processes of manufacturing copper coil and more particularly to a process of manufacturing copper coil by means of UV (ultraviolet) laser and copper coil thereof

### 2. Description of Related Art

Conventionally, a process of manufacturing an RF (radio frequency) coil having a diameter of less than 40 mm involves the step of spiraling a copper coil rather than by means of UV laser cutting. This is because a portion of the laser energy is absorbed by copper in the UV laser cutting step. Disadvantageously, the copper may be deformed due to thermal expansion. And in turn, the copper coil may have errors in shape and size. As a result, shape of the finished RF coil is not spiral-shaped.

Thus, the need for improvement still exists.

### SUMMARY OF THE INVENTION

It is therefore one object of the invention to provide a process of manufacturing a copper coil, comprising positioning a piece of copper having a thickness of at least 100 μm and flattening same; spirally cutting the piece of copper by means of UV laser to form a plurality of links and a plurality of grooves at either side of each link wherein the links are formed by portions of the piece of copper not cut by the UV laser; and cutting the links by means of the UV laser to connect the grooves together to finish a copper coil.

Preferably, the links are portions of the piece of copper not cut by the UV laser.

Preferably, the links are formed by controlling the UV laser by executing software.

Preferably, the number of the links is more than one.

Preferably, a diameter of the copper coil is no more than 40 mm.

The invention has the following advantageous effects in comparison with the prior art: A copper coil is manufactured by directly subjecting a copper substance to UV laser cutting. No deformation and size errors of the finished copper substance.

The above and other objects, features and advantages of the invention will become apparent from the following detailed description taken with the accompanying drawings.

### BRIEF DESCRIPTION OF THE DRAWINGS

FIG. 1 is a flow chart of a process of manufacturing a copper coil by means of UV laser according to the invention;

FIG. 2 is a schematic plan view of copper coil to be manufactured;

FIG. 3 is a detailed view of the area in circle A of FIG. 2; and

FIG. 4 is a detailed flow chart of the process of manufacturing a copper coil by means of UV laser according to the invention.

### DETAILED DESCRIPTION OF THE INVENTION

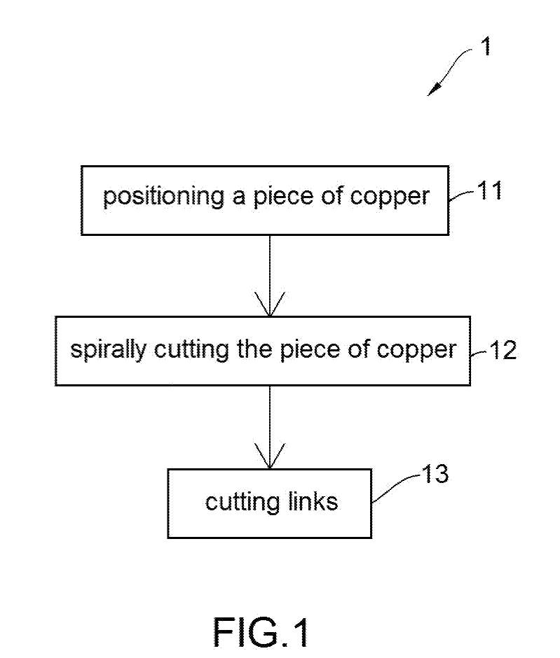

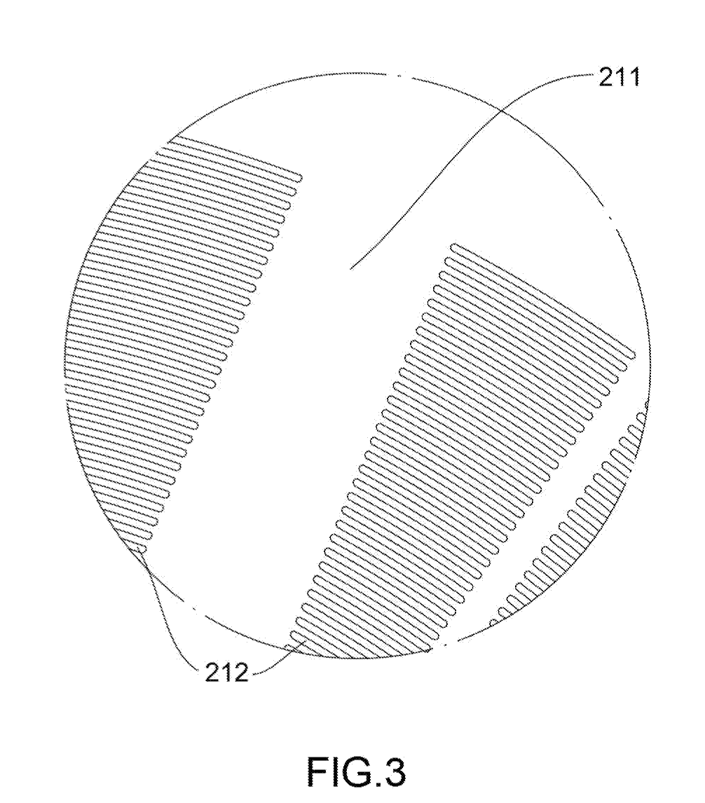

Referring to FIGS. 1 to 3, a process 1 of manufacturing a copper coil and a copper coil thereof 1 in accordance with the invention comprises the following steps as discussed in detail below.

Step 11: Positioning a copper substance 2 including a piece of copper 21 having a thickness of at least 100 μm and flattening same.

Step 12: Spirally cutting the piece of copper 21 by means of UV laser to form a plurality of links 211 and a plurality of grooves 212 at either side of the link 211.

Step 13: Cutting the links 211 by means of UV laser to connect the grooves 212 together to finish a copper coil.

The copper substance 2 includes a piece of copper 21 having a thickness of at least 100 μm and the piece of copper 21 includes a plurality of links 211 and a plurality of grooves 212 at either side of the link 211.

Each link 211 has a predetermined width and the links 211 are portions of the piece of copper 21 not cut by UV laser.

The grooves 212 are provided at either side of the link 211 and are oval. The grooves 212 are formed by UV laser.

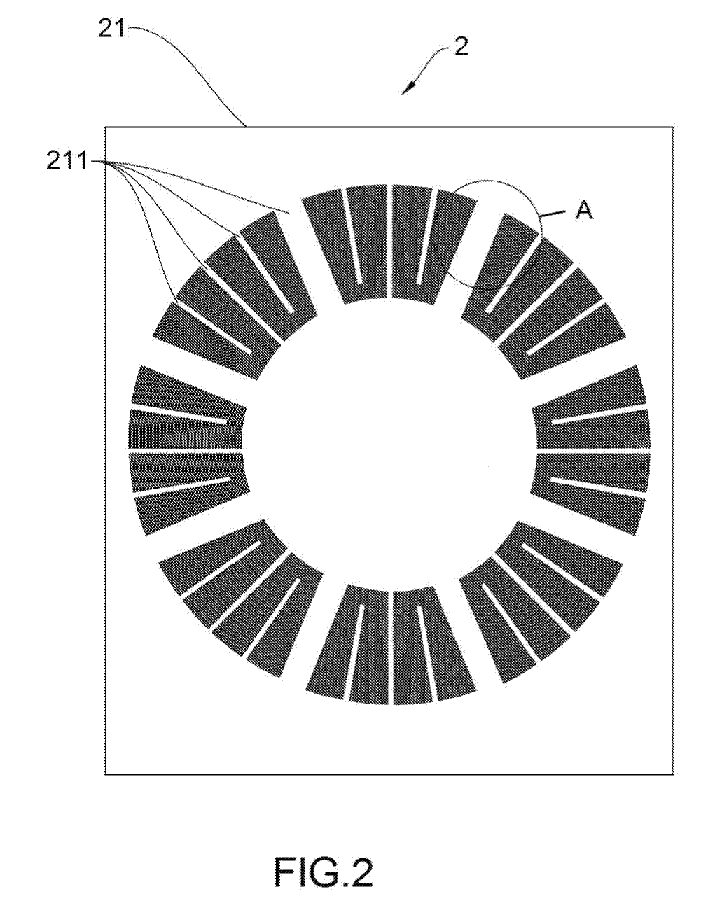

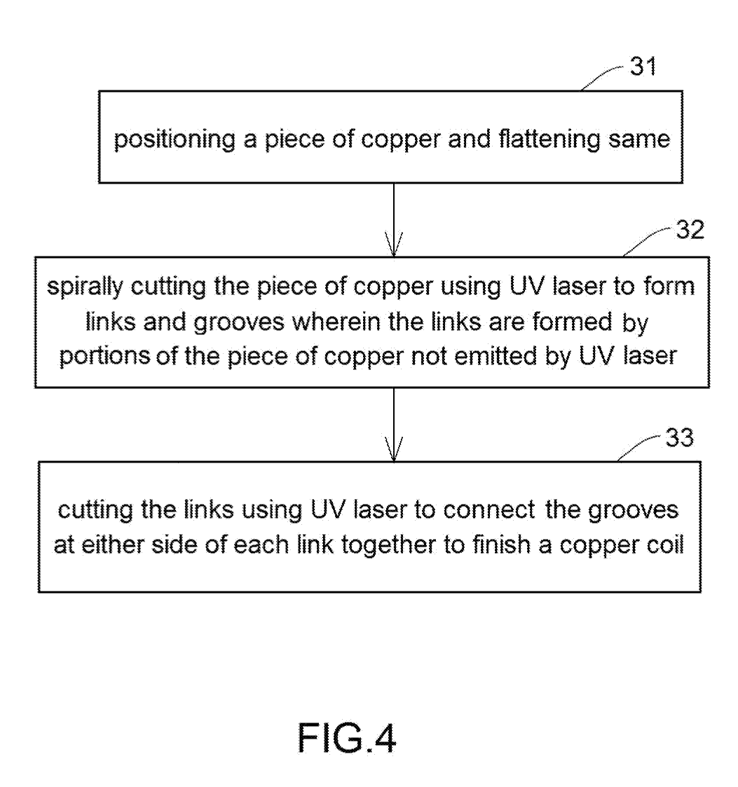

Referring to FIG. 4 in conjunction with FIGS. 1 and 2, a detailed process of manufacturing a copper coil in accordance with the invention is illustrated and comprises the following steps:

Step 31: Positioning a piece of copper 21 and flattening same. Otherwise, the half-finished product may be uneven to cause errors in the finished product.

Step 32: Mounting a UV laser cutter, spirally cutting the piece of copper 21 by means of UV laser to form a plurality of links 211 and a plurality of grooves 212 at either side of the link 211. The provision of the links 211 can prevent the copper coil from being displaced and having size errors. Further, the grooves 212 are not interconnected.

Portions of the piece of copper 21 not emitted by UV laser form the links 211. Alternatively, the UV laser cutter is programmed to emit on specified portions of the piece of copper 21 and the remaining portions form the links 211. Further, the links 211 may be not radial as that shown in FIG. 2 in other embodiments. The provision of the links 211 can prevent the copper coil from being displaced and having size errors. Further, it is possible of adjusting positions and number of the links 211 by calculating a correct length of the piece of copper to be cut without causing deformation.

Step 33: Cutting the links 211 by means of UV laser to connect the grooves 212 at either side of each link 211 together to form a long groove 212. As a result, a copper coil is finished.

The copper coil of the invention has a thickness of at least 100 μm and comprises links 211 and grooves 212. The links 211 are provided on the piece of copper 21 and have a predetermined width. The links 211 are portions of the piece of copper 21 not cut by the UV laser. The grooves 212 are provided at either side of each link 211 and are oval. The grooves 212 are formed by UV laser cutting. The copper coil has a diameter no more than 40 mm. The number of the links 211 is more than one.

The process of manufacturing copper coil and copper coil thereof according to the invention has the following advantageous effects in comparison with the prior art: A copper coil having a diameter of less than 40 mm is manufactured by directly subjecting a copper substance having a thickness of 100 μm to UV laser cutting. No deformation and size errors of the finished copper substance. The provision of the links can keep the manufactured copper coil having a uniform width, prevent the copper from absorbing too much heat caused by the UV laser, and thus preventing the copper coil from having errors in positions and sizes.

While the invention has been described in terms of preferred embodiments, those skilled in the art will recognize that the invention can be practiced with modifications within the spirit and scope of the appended claims.

What is claimed is:

1. A process of manufacturing a copper coil, comprising:
positioning a piece of copper having a thickness of at least 100 μm and flattening same;
spirally cutting the piece of copper by means of UV laser to form a plurality of links and a plurality of grooves at either side of each link wherein the links are formed by portions of the piece of copper not cut by the UV laser; and
cutting the links by means of the UV laser to connect the grooves together to finish a copper coil.

2. The process of manufacturing a copper coil of claim 1, wherein the links are portions of the piece of copper not cut by the UV laser.

3. The process of manufacturing a copper coil of claim 1, wherein the links are formed by controlling the UV laser by executing software.

4. The process of manufacturing a copper coil of claim 1, wherein the number of the links is more than one.

5. The process of manufacturing a copper coil of claim 1, wherein a diameter of the copper coil is no more than 40 mm.
